(19) United States
(12) Patent Application Publication
(10) Pub. No.: US 2013/0039061 A1
(43) Pub. Date: Feb. 14, 2013

(54) LIGHT DISPLAY METHOD AND LIGHT DISPLAY DEVICE

(71) Applicants: Eiichi Sato, Hachioji-shi (JP); Hiroyasu Sato, Hachioji-shi (JP); Ken Sato, Hachioji-shi (JP)

(72) Inventors: Eiichi Sato, Hachioji-shi (JP); Hiroyasu Sato, Hachioji-shi (JP); Ken Sato, Hachioji-shi (JP)

(73) Assignee: OPTO DESIGN, INC., Hachioji-shi, Tokyo (JP)

(21) Appl. No.: 13/641,391

(22) PCT Filed: Apr. 15, 2011
(86) PCT No.: PCT/JP2011/059444

§ 371 Date: Oct. 15, 2012

(30) Foreign Application Priority Data
Apr. 16, 2010 (JP) 2010-095277

(51) Int. Cl. F21S 4/00; F21V 7/00

(52) U.S. Cl. 362/235; 362/227

(57) ABSTRACT

[Purpose] A light display method is capable of providing planar light displays of various types of characters with increased degrees of freedom, by using a plurality of point light sources and making light source units interchangeable on a point light source basis.

[Constitution] In a light display method making light displays of various types of characters by employing a plurality of point light sources, each light display of the characters A, N, O, and S is made by dividing and segmenting the characters into at least one or more sets of light source units a1, n1, o1, o2, o3, s1, s2, and s3 including at least one of the point light sources, having a common structure in each character A, N, O, and S or a plurality of different characters, and making illumination by light emitted from the point light source as planar illumination light.

### TECHNICAL FIELD

The present invention relates to a light display method and a light display device, and more specifically, relates to a light display method and a light display device that employ a plurality of point light sources to make light displays of various types of characters such as kanji characters, katakana characters, alphabetic characters, numeric characters, graphics, and symbols.

### BACKGROUND ART

In recent years, study, research and development on light emitting diodes (hereinafter, called LEDs) have advanced tremendously, resulting in the development of LEDs capable of being used for wider purposes. Recently, LEDs have been used as a light source for lighting of, for example, various advertising displays, vehicle interior lighting, traffic signs, and signboards. Comparing with related art light sources such as an incandescent bulb and a fluorescent lamp, LEDs have advantages, for example, extremely high energy efficiency, long service life of LED elements, and low electric power consumption, as well as having a very small elemental device allowing it to be mounted in small spaces. The application range of LEDs is therefore expected to increase further.

For example, Patent Document 1 describes, as shown in FIG. 11, a planar illumination light source device 30 using a plurality of LEDs to make light displays of characters. The planar illumination light source device 30 is for making light displays of, for example, the alphabetic character A, and includes a housing 31 having a shape of the character A, a plurality of LEDs 32 spaced apart from each other by a predetermined distance in the housing, a light reflection plate 34 covering an opening of the housing, and a light, diffusion plate 35 disposed opposite to and apart from the light reflection plate by a predetermined distance. The plurality of LEDs 32 are divided by partitions 36 to be disposed in the housing. The light reflection plate 34 includes a center reflection part having high light reflectivity in a region corresponding to the periphery of the optical axis of each LED and outer reflection parts having lower light reflectivity as the distance from the center reflection part increases, thereby achieving substantially uniform dispersion of light emitted from the LEDs for illumination.

### CITATION LIST

### Patent Document

[Patent Document 1] JP-A-2008-27886 (paragraphs [0093] to [0095], FIG. 13)

### DISCLOSURE OF INVENTION

### Problem to be Solved by the Invention

The planar illumination light source device disclosed in Patent Document 1 can make a light display of, for example, the alphabetic character A, using a plurality of LEDs. In order to display the character A, however, it is required to produce a planar illumination light source device corresponding to the character. Hence, when light displays of characters other than the character A are intended to be made, a planar illumination light source device corresponding to each character is required. In other words, displaying various types of characters requires various planar illumination light source devices corresponding to the characters. The type and the number of various characters are, however varied depending on displayed characters. To address this, a wide variety of planar illumination light source devices are required. It is not realistic to prepare the wide variety of planar illumination light source devices in advance and such a planar illumination light source device must be customized in each case depending on the need for the character to be displayed. In the customization, a device cannot be mass-produced because the device is produced after an order is received, resulting in low productivity and increased cost.

Furthermore, the character display requires a planar illumination light source device corresponding to each character and hence, has problems in which the character display cannot be applied with respect to a wide variety of light displays, the number of processes for installation is large, and the degree of freedom of display is limited. For example, the planar illumination light source device disclosed in Patent Document 1 is to make a light display of the character A. When light displays of other characters, for example, katakana characters, kanji characters, and other characters except letters, such as graphics and symbols are made, a planar illumination light source device corresponding to each character is required in a similar manner.

The present inventors have studied how to solve the problems possessed by a related art planar illumination light source device. As a result, the present inventors have found that, because LEDs alone are common parts among parts constituting the device and other parts are different from each other in the illumination device for the character hr by dividing and segmenting the illumination device into parts having a common structure, that is, into at least one or more sets of light source units, a common set of light source units enables the interchange of parts. In the dividing and segmenting, when another character is divided and segmented into parts in a similar manner, the parts can be interchanged among other characters. The invention is achieved based on the findings.

An object of the invention is to provide a light display method and a light display device capable of providing planar light displays of various types of characters such as kanji characters, katakana characters, alphabetic characters, numeric characters, graphics, and symbols, with increased degrees of freedom, by using a plurality of point light sources and making light source units interchangeable on a point light source basis.

Another object of the invention is to provide a light display method and a light display device capable of providing planar light displays while reducing the number of point light sources by enlarging the planar illumination area of a point light source unit.

Another object of the invention is to provide a light display device that achieves the objects, is easily assembled and inexpensive, and can be used for various types of characters.

### Means for Solving Problem

In order to achieve the objects, a light display method of the invention includes making light displays of various types of characters by employing a plurality of point light sources. In the light display method, each light display of the characters is made by dividing and segmenting the characters into at least one or more sets of light source units including at least one of the point light sources, having a common structure in each character or a plurality of different characters, and making illumination by light emitted from the point light source as planar illumination light.

By the light display method of the invention, light displays of various types of characters are made by dividing and segmenting into light source units having a common structure. Hence, common light source units can be used to make light displays of various types of characters such as kanji characters, katakana characters, alphabetic characters, numeric characters, and graphics, with increased degrees of freedom. In other words, light displays of various types of characters such as kanji characters, katakana characters, alphabetic characters, numeric characters, graphics, and symbols are made by dividing and segmenting the characters into at least one or more sets of light source units having a common structure in each character or a plurality of different characters and making illumination as planar illumination light, thereby enabling light displays with increased degrees of freedom of display.

In the light display method of the invention, it is preferable that the light source unit have a rectangular solid shape, a folded solid shape, or a curved shape, include a unit case having a bottom with the point light source and having an opening, and also include a light reflection plate covering the opening of the unit case and outputting light emitted from the point light source as planar illumination light, and that such light source units be used in combination to make light displays of the characters.

By using a light source unit having a rectangular solid shape, a folded solid shape, or a curved shape for the light display method of the invention, light displays of various types of characters can be easily made; that is, light displays can be made with increased degrees of freedom of display.

In the light display method of the invention, it is preferable that the light source unit be stored in a character case having an opening and the opening be covered with a light diffusion plate to make light displays of the characters.

By the light display method of the invention, the light source unit is stored in the character case and covered with the light diffusion plate. Even when a point light source is used, light display can be therefore made by substantially uniform illumination light from the light diffusion plate.

In order to achieve the objects, a light display device of the invention employs a plurality of point light sources to make light displays of various types of characters. In the light display device, each light display of the characters is made by dividing and segmenting the characters into at least one or more sets of light source units including at least one of the point light sources, having a common structure in each character or a plurality of different characters, and making illumination by light emitted from the point light source as planar illumination light.

With the light display device of the invention, the light display device for various types of characters makes light displays by dividing and segmenting into light source units having a common structure. Hence, common light source units in various types of characters such as kanji characters, katakana characters, alphabetic characters, numeric characters, and graphics can be used to make light displays, with increased degrees of freedom. In other words, the light display device for various types of characters can make light displays by dividing and segmenting the characters into at least one or more sets of light source units having a common structure in each character, for example, a kanji character, a katakana character, an alphabetic character, a numeric character, a graphic, or a symbol or a plurality of different characters and making illumination as planar illumination light, thereby enabling light displays with increased degrees of freedom of display.

In the light display device of the invention, it is preferable that the light source unit have a rectangular solid shape, a folded solid shape, or a curved shape as an overall shape and include a unit case having a bottom with the point light source and having an opening opposed to the bottom, and also include a light reflection plate covering the opening and outputting light emitted from the point light source as planar illumination light, and that such light source units be used in combination to make light displays of the characters.

With the light display device of the invention, the light source units having a rectangular solid shape, a folded solid shape, or a curved shape are used in an appropriate combination, thereby enabling easy light displays of various types of characters; that is, enabling light displays with increased degrees of freedom of display.

In the light display device of the invention, it is preferable that a character case corresponding to each character and having an opening be provided, the light source units be each stored in the character case, and the opening be covered with a light diffusion plate.

The light display device of the invention can provide uniform illumination light from the light diffusion plate provided on the opening, thereby enabling light displays of characters with high quality.

In the light display device of the invention, it is preferable that the light diffusion plate include a cover covering the opening of the character case and the opening be sealed up with the cover.

With the light display device of the invention, the opening of the character case is sealed up with the cover. Such a structure prevents the entry of undesired substances such as insects and dusts into the light display device, thereby preventing the deterioration of illumination quality. Furthermore, waterproof sealing can make the light display device waterproof.

In the light display device of the invention, it is preferable that the light reflection plate be apart from the point light source by a predetermined distance and include a center reflection part having high light reflectivity and low light transmittance in a predetermined region of which center is the optical axis of the point light source and an outer reflection part having a gradually reduced light reflectivity and an increased light transmittance as the distance from the periphery of the center reflection part increases.

With the light display device of the invention, even when a point light source having strong directivity is used, substantially uniform illumination light can be emitted from the light reflection plate.

### BRIEF DESCRIPTION OF DRAWINGS

FIG. 1 is a plan view of character examples for light displays by a light display method of an embodiment of the invention.

FIG. 2 is a plan view of the characters in FIG. 1 divided and segmented into a plurality of light source units.

FIG. 3 shows the rectangular solid light source unit in FIG. 2, FIG. 3A being a general perspective view and FIG. 3B being an exploded perspective view.

FIG. 4 is a view showing typical optical directional characteristics of an LED.

FIG. 5 shows the folded solid light source units in FIG. 2, FIG. 5A being a perspective view and an exploded perspective view of one folded solid light source unit, and FIG. 5B being a perspective view and an exploded perspective view of the other folded solid light source unit.

FIG. 6 is a perspective view of alternative examples of the folded solid light source unit in FIG. 5.

FIG. 7 is a plan view of a light display device of an embodiment of the invention.

FIG. 8 is an exploded perspective view of the light display device in FIG. 7.

FIG. 9 is a sectional view taken along the line IX-IX in FIG. 7.

FIG. 10 is an exploded perspective view of another light display device.

FIG. 11 shows a related art planar illumination light source device, FIG. 11A being a perspective view, FIG. 11B being a sectional view, and FIG. 11C being a front view.

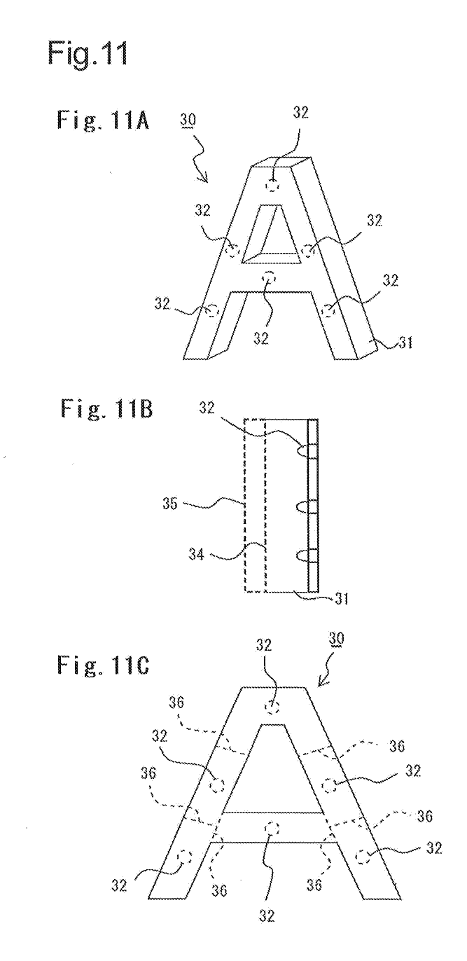

### BEST MODE(S) FOR CARRYING OUT THE INVENTION

Embodiments of the invention will now be described with reference to the accompanying drawings. The embodiment, shown below is, however, an illustrative example of the light display method and the light display device for embodying the technical spirit of the invention, is not intended to limit the invention to them, and may equally be applied to other embodiments within the scope of the claims.

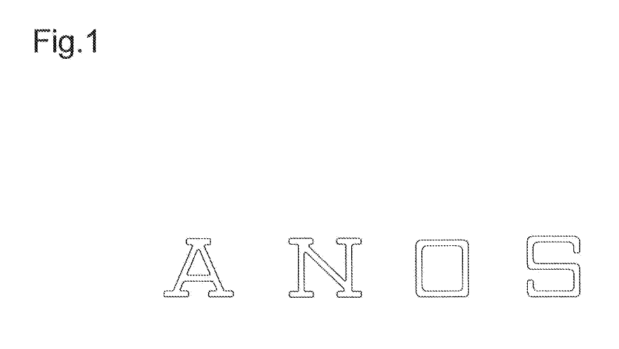

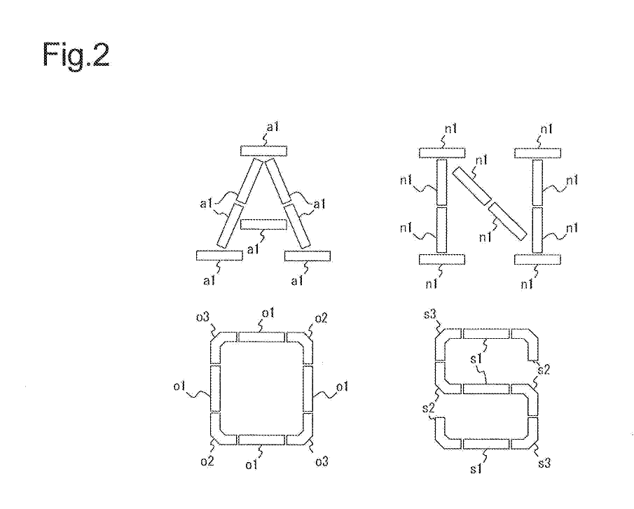

With reference to FIG. 1 and FIG. 2, a light display method of an embodiment of the invention will be described. FIG. 1 is a plan view of character examples for light displays by the light display method of an embodiment of the invention and FIG. 2 is a plan view of the characters in FIG. 1 divided and segmented into a plurality of light source units.

As the light display method of the embodiment of the invention, as shown in FIG. 1, a method for light displays of alphabetic characters A, N, O, and S will be described. The characters in FIG. 1 are light display devices described later.

The light display method is a method for light displays by dividing and segmenting the alphabetic characters A, N, O, and S into at least one or more sets of light source units having a common structure in each of the alphabetic characters or these characters. The light source unit includes an LED, a unit housing storing the LED and having an opening, and a light reflection plate covering the opening of the housing and outputting light emitted from the LED for planar illumination, as described later.

For the alphabetic characters A, N, O, and S, standard alphabetic character logotypes are changed and then divided and segmented into at least one set of light source unit having a common structure in each alphabetic character A, N, O, or S and these alphabetic characters so that the number of light source unit types is as small as possible. For example, the uppercase alphabetic character A is divided and segmented into eight light source units a1 having a common structure as shown in FIG. 2. Each light source unit a1 is a rectangular solid (hereinafter, called rectangular solid light source unit) having a predetermined length. By the segmentation, the uppercase alphabetic character A includes the light source units a1 each having a common structure. The light source unit a1 can also be used for other uppercase alphabetic characters. The other uppercase alphabetic characters are divided and segmented in a similar manner. The uppercase alphabetic character N is divided and segmented into ten light source units n1, the uppercase alphabetic character O is divided and segmented into four light source units o1, two light source units o2, and two light source units o3, and the uppercase alphabetic character S is divided and segmented into three light source units s1, four light source units s2, and two light source units s3. By these segmentations, each of the light source units a1, n1, o1, and s1 in the uppercase alphabetic characters A, N, O, and S has a rectangular solid shape having a common structure, each of the light source units o2 and s2 has a folded solid shape having a common structure, and each of the light source units o3 and s3 has a folded solid shape having a common structure.

By the division and segmentation of the alphabetic characters A, N, O, and S, light displays of these characters can be made using three types of light source units including a rectangular solid light source unit and two types of folded solid light source units.

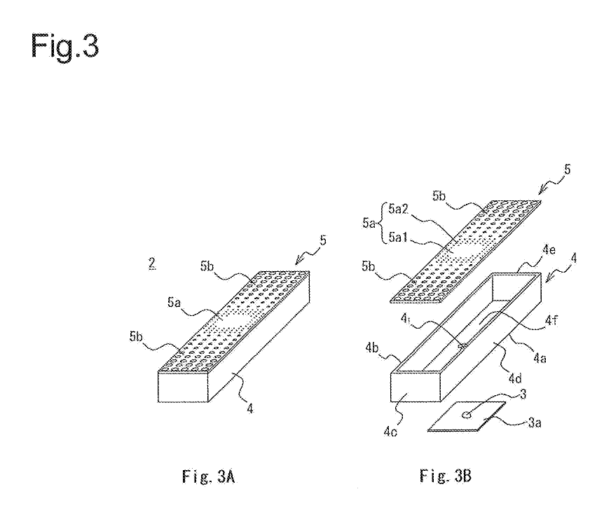

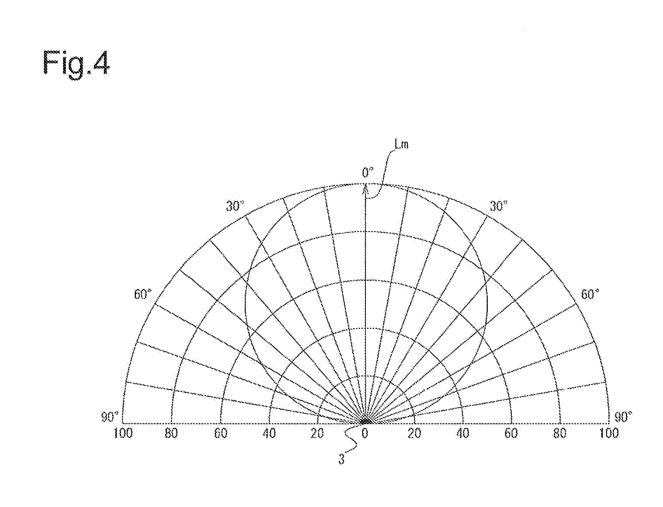

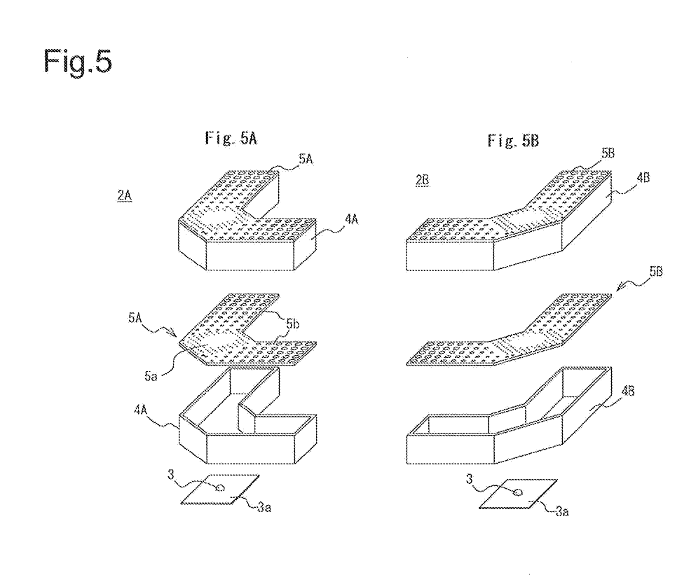

Structures of the rectangular solid light source unit and the folded solid light source units will be described hereinafter with reference to FIGS. 3 and 4. FIG. 3 shows the rectangular solid light source unit, FIG. 3A being a perspective view and FIG. 3B being an exploded perspective view. FIG. 4 is a typical optical directional curve of an LED. FIG. 5 shows the folded solid light source units, FIG. 5A being a perspective view and an exploded perspective view of one folded solid light source unit and FIG. 5B being a perspective view and an exploded perspective view of the other folded solid light source unit.

The rectangular solid light source unit 2 includes, as shown in FIG. 3, an LED 3, a unit case 4 having the LED disposed on the bottom and also having an upper opening, and a light reflection plate 5 covering an opening 4f of the case and outputting light emitted from the LED for planar illumination. The LED 3 is an LED including one light-emitting element or a plurality of assembled light-emitting elements and the LED to be used emits white light or another color light, for example, red, green, or blue. The LED 3 is fixed to a substrate 3a having a predetermined shape and is exposed into the case through a through-hole 4₁ in the bottom of the unit case 4. The LED 3 shows the highest luminance Lm at a beam spread angle of zero and has optical directional characteristics with an approximately spherical shape as a whole in which the luminance decreases as the angle increases, as shown in FIG. 4. Another point light source such as a laser diode may be used in place of the LED.

The unit case 4 includes, as shown in FIG. 3B, a rectangular solid box that includes a bottom 4a having a rectangular shape with a pair of long sides opposed to each other and a pair of short sides opposed to each other, side panels 4b to 4e having a predetermined height and standing from the periphery of the bottom, and an opening 4f at the top of each side panel, that is, on a face opposed to the bottom. The bottom 4a includes the through-hole 4₁ for exposing the LED 3 into the case. Inner walls of the box are processed to have high reflectivity. The whole of the unit case is preferably formed by an ultrafinely foamed reflection plate (trade name: MCPET). In the embodiment, one LED is disposed in the unit case 4, but a plurality of LEDs may be disposed.

The light reflection plate 5 includes, as shown in FIG. 3, a center reflection part 5a having a predetermined area at the center in the longitudinal direction and outer reflection parts 5b extending from the periphery of the center reflection part to the longitudinal direction and is formed by a reflection plate having a size covering the opening 4f of the unit case 4. The reflection plate is preferably formed by an ultrafinely foamed reflection plate (trade name: MCPET) having reflection faces on the front and back faces of the plate. The center reflection part 5a of the light reflection plate 5 is a region having a predetermined area and the center of the region is the optical axis of the LED 3. The region includes a region 5a1 that is close to the optical axis and has the highest light reflectivity and the lowest light transmittance, and a region 5a2 that is formed around the region 5a1 and has a slightly lower light reflectivity and a higher light transmittance than those of the region 5a1. The light reflectivity of the region 5a1 is appropriately designed by the selection of a light reflection plate material and the processes (for example, the formation of half-grooves and the adjustment of plate thickness) of the material, thereby efficiently using light. The region 5a2 includes micropores. The micropores may be replaced by slits, microgrooves, or the like. The outer reflection part 5b is a region in which light reflectivity decreases and in which light transmittance increases as the distance from the periphery of the center reflection part 5a increases. The outer reflection part 5b includes a reflection plate having through-holes with a predetermined aperture ratio, thereby adjusting the light reflectivity and the light transmittance.

The rectangular solid light source unit 2 is assembled by installing the LSD 3 onto the bottom of the unit case 4 and covering the opening 4f with the light reflection plate 5. In the assembled rectangular solid light source unit 2, when the LED 3 is lighted, emitted light having the highest luminance is highly reflected by the center; reflection part 5a, then is multiply reflected between the reflection face of the light, reflection plate 5 and the inner reflection faces of the unit case 4, and is output from the outer reflection part 5b, thereby outputting substantially uniform illumination light from the surface of the light reflection plate. The center reflection part 5a has high reflectivity and low light transmittance. A bright spot therefore does not remain in the area and glare that is unpleasant brightness is not generated.

The folded solid light source unit includes, as shown in FIG. 5, two types of folded solid light source units 2A and 2B having folding directions different from each other. One folded solid light source unit 2A includes, as shown in FIG. 5A, one LED 3, a unit case 4A having the LED disposed on the bottom and also having an upper opening, and a light reflection plate 5A covering the opening of the case and outputting light emitted from the LED for planar illumination. The LED 3 is the same as the LED in the rectangular solid light source unit 2.

The unit case 4A has a shape in which the unit case 4 having a rectangular solid shape is folded at approximately the center in a predetermined direction by a predetermined angle. The area of the opening 4f of the unit case 4 is substantially the same as the area of the opening of the unit case 4A. The unit case 4A includes a folding part at approximately the center and extending parts extended from both sides of the folding part and having a predetermined length, and is formed into an approximately arc shape as a whole. The folding angle is an angle suitable for the shape of a display character. The folding part includes a bottom in which a through-hole is formed for exposing the LED 3 into the ease. Other structures are the same as those of the unit case 4.

The light reflection plate 5A is, as shown in FIG. 5A, formed by a reflection plate having a size covering the opening of the unit case 4A and includes a center reflection part 5a having a predetermined area in a region corresponding to the folding part of the unit case and outer reflection parts 5b in regions corresponding to the extending parts. Other structures are the same as those of the light reflection plate 5. With the folded solid light source unit 2A, substantially uniform illumination light is output from the surface of the light reflection plate 5A. The center reflection part 5a has high reflectivity and low light transmittance. A bright spot therefore does not remain and glare that is unpleasant brightness is not generated.

The other folded solid light source unit 2B has the same structure as that of the folded solid light source unit 2A except that the folding direction is different. In other words, the folded solid light source unit 2B includes an LED 3, a unit case 4B having the LED disposed on the bottom and also having an upper opening, and a light reflection plate 5B covering the opening of the case and outputting light emitted from the LED for planar illumination. With the folded solid light source unit 2B, substantially uniform illumination light is also output from the surface of the light reflection plate 5B.

In the light display method of the embodiment, the rectangular solid light source unit and the folded solid light source units are used, but the light source unit is not limited to them, and light source units having various shapes such as a curved shape may be used depending on the character to be displayed. When light source units having various shapes are used, the light source units preferably have substantially the same opening area. This is because when opening areas are different from each other depending on light source units, light source units in which the type and the number of LEDs used as the light source are the same but the openings have varied areas provide varied illumination intensities; that is, a unit having a small opening area is relatively bright and a unit having a large opening area is relatively dark, resulting in non-uniform illumination intensity as a whole.

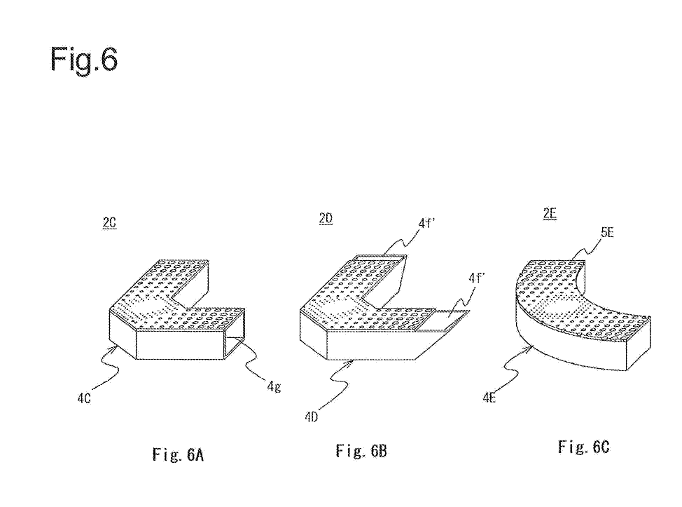

With reference to FIG. 6, alternative examples of the folded solid light source unit of the embodiment will be described. FIG. 6 is a perspective view of the alternative examples of the folded solid light source unit of the embodiment. These alternative examples of the folded solid light source unit have a common structure to the structure of the folded solid light source unit 2A except some components, and hence, the common description will be left out. These alternative examples can be applied to the rectangular solid light source unit in a similar manner.

FIG. 6A is a perspective view of an alternative example of the folded solid light source unit in which any of the side panels of the unit case is left out. In a folded solid light source unit 2C, any of the side panels of a unit case 4C is left out and a side opening 4g is provided. When unit cases are disposed depending on various characters, a clearance may be generated between some unit cases, or between a unit case and a character frame case 11 described later due to a character shape. For such a case, any of the side panels adjacent to the clearance is left out to make the side opening 4g that transmits light from an LED, thereby suppressing the reduction in brightness in an area corresponding to the clearance on an illumination face. Alternatively, the side panel may be provided with an opening having a predetermined area and this can provide the same effect as the case in which a side panel is left out.

FIG. 6B is a perspective view of an alternative example of the folded solid light source unit in which any of the side panels of the folded solid light source unit in FIG. 5 is tilted. In a folded solid light source unit 2D, any of the side walls of a unit case 4D is tilted at a predetermined angle (for example, 135°) with respect to the bottom. The tilt angle is preferably more than 90° and about 150° at most with respect to the bottom. By tilting a side panel, the opening of the unit case can be enlarged and LED light can be efficiently output toward the opening using the slope. In the alternative example, any of the side panels is tilted but all the side panels may be tilted from the periphery of the bottom to the outside at a predetermined angle.

In the alternative example, a light reflection plate 5D is not changed and the enlarged area in an opening 4f of the unit case is not covered with the light reflection plate to make an end opening 4f′. Depending on the shape of a unit case, illumination intensity may be reduced in the end area apart from an LED. For such a case, when the opening 4f′ is provided at the end of the unit case, illumination intensity is not reduced even on a light emitting face at the end of the folded solid light source unit to which light from an LED is unlikely to reach, thereby obtaining uniform illumination light. The light reflection plate 5D may have an enlarged area corresponding to an enlarged opening of the unit case to completely cover the opening 4f of the unit case.

FIG. 6C is a perspective view of an alternative example in which the shape of the folded solid light source unit in FIG. 5 is changed. A curved light source unit 2E has an arc shape by changing the shape of the folded solid light source unit 2A. A unit case 4E has an LED at the bottom center and is formed into an arc shape as a whole. The length of the arc is designed so as to fit the shape of a display character. Other components are the same as those of the unit case 4A.

A light reflection plate 5E is formed by a reflection plate having a size covering the opening of the unit case 4E and includes a center reflection part 5a having a predetermined area in a region corresponding to the LED disposed in the unit case and outer reflection parts 5b in regions corresponding to the extending parts. Other components are the same as those of the light reflection plates 5 and 5A. With the folded solid light source unit 2E, substantially uniform illumination light is also output from the surface of the light reflection plate 5A. As described above, the shape of the light source unit is not limited to them and can be changed corresponding to the shape of the character to be displayed.

By the light display method of the embodiment, characters are divided and segmented into at least one or more sets of light source units having a common structure in each of uppercase alphabetic characters A, N, O, and S and these characters. Hence, the light source units are interchangeable, that is, unit parts are common, thereby making light displays of the alphabetic characters A, N, O, and S using a few types of parts. By the display method, various characters except the alphabetic characters A, N, O, and S, for example, kanji characters, katakana characters, numeric characters, graphics, and symbols can also be made into light displays. In other words, light displays of various types of characters can be made with increased degrees of freedom of display. Moreover, preparation and management of parts become easier and the parts can be prepared at low cost because the unit parts are interchangeable.

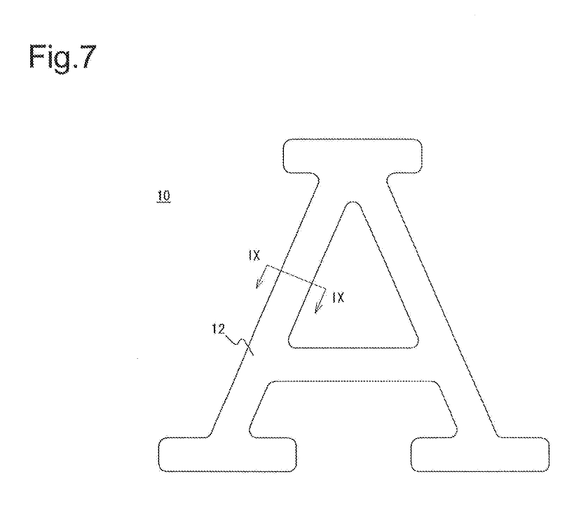

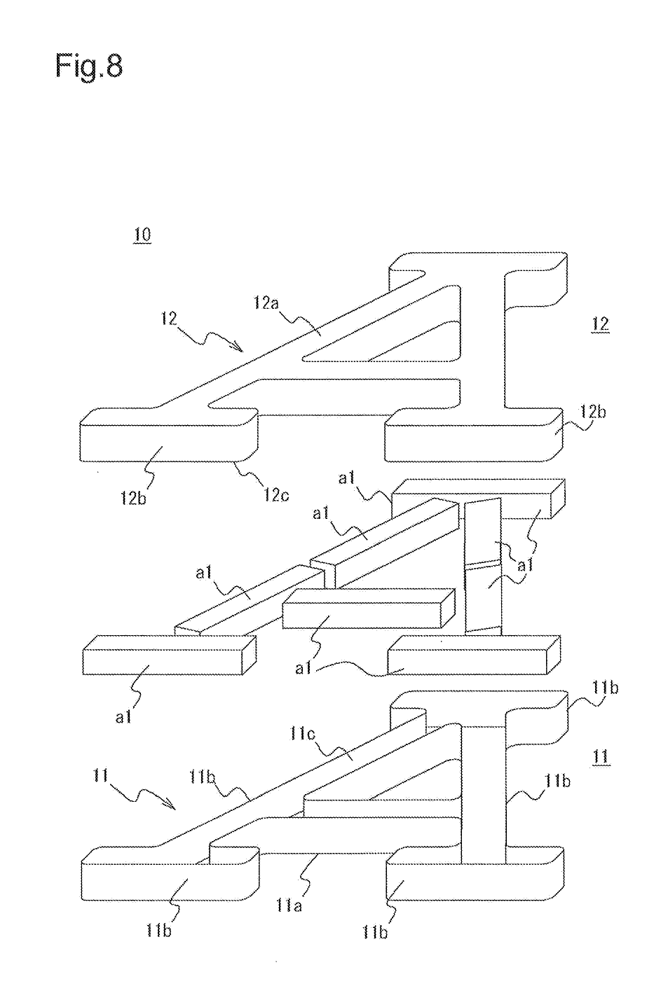

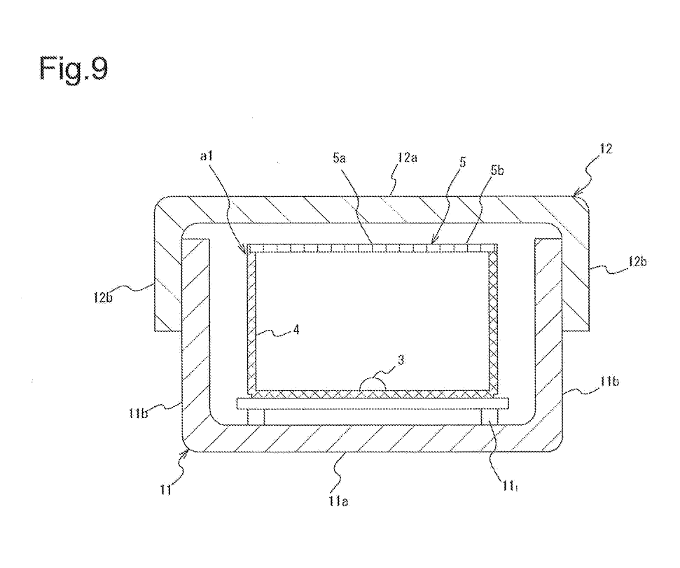

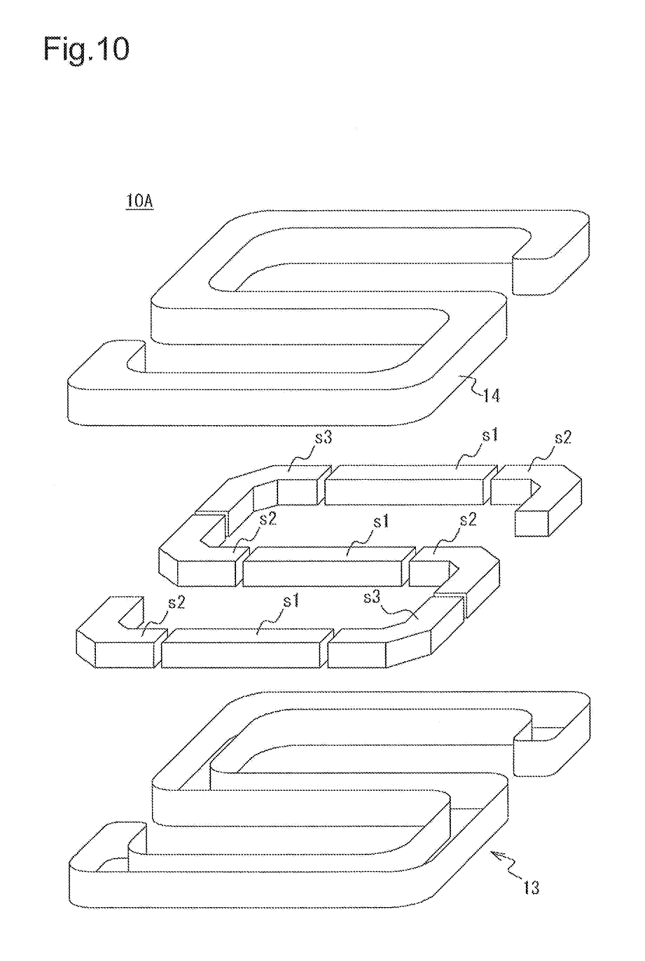

With reference to FIGS. 7 to 10, a light display device of an embodiment of the invention will be described. FIG. 7 is a plan view of the light display device of the embodiment of the invention. FIG. 8 is an exploded perspective view of the light display device in FIG. 7. FIG. 9 is a sectional view taken along the line IX-IX in FIG. 7. FIG. 10 is an exploded perspective view of another light display device.

FIGS. 7 and 8 show a light display device to make a light display of an uppercase alphabetic character A. The light display device 10 includes, as shown in FIG. 8, a character frame case 11 having a character A shape, a plurality of light source units a1 to be stored in the character frame case, and a cap 12 for covering an opening of the character frame case. The cap 12 is expressed as a cover in the claims. The character frame case 11 is formed by a frame that includes a bottom plate 11a having a character A shape, side panels lib having a predetermined height and standing from the bottom plate, and an opening 11c being an open face opposed to the bottom plate and being at the top of each side panel and that includes a space having a size capable of storing therein the plurality of light source units a1. The frame is formed by a molded body made of, for example, a synthetic resin or a metal plate. The character frame case 11 is a changed standard logotype so as to store the plurality of light source units a1 having a common structure. In the character frame case 11, inner walls are preferably reflection faces. The character frame case 11 includes the bottom plate 11a having a fixing part 11₁ for fixing the light source unit a1 and having an attaching part for attaching the case onto, for example, an exterior wall of a building. The fixing part 11₁ is provided on an inner wall of the bottom plate 11a and the attaching part is provided on a back side of the bottom plate 11a.

All the plurality of light source units a1 employ the rectangular solid light source unit 2 shown in FIG. 3. The cap 12 includes a ceiling plate 12a having a character A shape, side panels 12b having a predetermined length and hanging from the ceiling plate, and an opening 12c being an open face opposed to the ceiling plate and being at the top of each side panel. The opening is formed to have a size to close the opening 11c of the character frame case 11. The cap 12 is integrally molded using a light diffusion member, for example, a synthetic resin material such as an acrylic resin. The whole cap 12 is formed by a light diffusion member, but the ceiling plate 12a may be formed by a light diffusion member.

For the assembly of the light display device 10, the plurality of light, source units a1 are firstly disposed in the character frame case 11. Each light source unit a1 is fixed to the bottom plate list of the character frame case 11 with the fixing part 11₁. Then, the opening of the character frame case 11 is covered with the cap 12, which is then fixed.

In the light display device 10, when the LED 3 in each light source unit a1 is lighted, a large part of emitted light in every light source unit having the highest luminance is reflected by the center reflection part 5a, then is multiply reflected between the reflection face of the light reflection plate 5 and the inner reflection faces of the unit case 4, and is output from the outer reflection part 5b, thereby outputting substantially uniform illumination light from the surface of the light reflection plate. The center reflection part 5a has high light reflectivity and low light transmittance. A bright spot therefore does not remain in the area and bright glare is not generated. Furthermore, each light source unit a1 is covered with the cap 12 and the cap 12 is a light diffusion plate. Hence, uniform illumination light is output from the surface of the diffusion plate, thereby making the light display of the uppercase alphabetic character A. Moreover, because the light source units are interchangeable in the light display device of the embodiment, preparation and management of parts become easier and the parts can be prepared at low cost. Furthermore, the character frame case 11 is sealed up with the cap 12, thereby preventing the entry of undesired substances such as insects and dust into the light display device. In addition, waterproof sealing can make the light display device waterproof.

With reference to FIG. 10, the light display device to make a light display of a character S will be described.

The light display device 10A includes a character frame case 13 having a character S shape, a plurality of light source units s1 to s3 to be stored in the character frame case, and a cap 14 for covering an opening of the character frame case. The character frame case 13 is formed by a frame that includes a bottom plate having a character S shape, side panels having a predetermined height and standing from the bottom plate, and an opening being an open face opposed to the bottom plate and being at the top of each side panel and that includes a space having a size capable of storing the plurality of light source units s1 to s3. The frame is formed by a molded body made of, for example, a synthetic resin or a metal plate. The character frame case 13 is a changed standard logotype so as to store the plurality of light source units s1 to s3 each having a common structure. In the character frame case 13, inner walls are preferably reflection faces.

The plurality of light source units s1 to s3 employ the rectangular solid light source unit 2 and the folded solid light source units 2A and 2B shown in FIGS. 3 and 5. The cap 14 includes a ceiling plate having a character S shape, side panels having a predetermined length and hanging from the ceiling plate, and an opening being an open face opposed to the ceiling plate and being at the top of each side panel. The opening is formed to have a size to close the opening of the character frame case 13. The cap 14 is integrally molded using a light diffusion member, for example, a synthetic resin material such as an acrylic resin. The whole cap 14 is formed by a light diffusion member, but the ceiling plate 12a may be formed by a light diffusion member. The light display device 10A provides the same action and effect as the light display device 10.

In the light display device of the embodiment, the rectangular solid light source unit and the folded solid light source units are used, but the light source unit is not limited to them, and light source units having various shapes such as a curved shape may be used depending on the character to be displayed. When light source units having various shapes are used, these light source units preferably have substantially the same opening area. This is because when opening areas are different from each other depending on light source units, light source units in which the type and the number of LEDs used as the light source are the same but the openings have varied areas, provide varied illumination intensities, resulting in non-uniform illumination intensity as the whole of the light display device.

### EXPLANATIONS OF LETTERS OR NUMERALS

a1, n1, o1, o2, o3, s1, s2, s3 light source unit
2 rectangular solid light source unit
2A, 2B folded solid light source unit
3 LED
4, 4A, 4B unit housing
5, 5A, 5B light reflection plate
5a center reflection part
5b outer reflection part
10, 10A light display device
11, 13 character frame case
12, 14 cap (light diffusion plate)

1. A light display method comprising:
making light displays of various types of characters by employing a plurality of point light sources,
each light display of the characters being made by dividing and segmenting the characters into at least one or more sets of light source units including at least one of the point light sources, having a common structure in each character or a plurality of different characters, and making illumination by light emitted from the point light source as planar illumination light.

2. The light display method according to claim 1, wherein the light source unit has a rectangular solid shape, a folded solid shape, or a curved shape and includes a unit case having a bottom with the point light source and having an opening, and also includes a light reflection plate covering the opening of the unit case and outputting light emitted from the point light source as planar illumination light, and such light source units are used in combination to make light displays of the characters.

3. The light display method according to claim 1, wherein the light source unit is stored in a character case having an opening and the opening is covered with a light diffusion plate to make light displays of the characters.

4. A light display device comprising:
a plurality of point light sources to make light displays of various types of characters,
each light display of the characters being made by dividing and segmenting the characters into at least, one or more sets of light source units including at least one of the point light sources, having a common structure in each character or a plurality of different characters, and making illumination by light emitted from the point light source as planar illumination light.

5. The light display device according to claim 4, wherein the light source unit has a rectangular solid shape, a folded solid shape, or a curved shape as an overall shape and includes a unit case having a bottom with the point light source and having an opening opposed to the bottom, and also includes a light reflection plate covering the opening and outputting light emitted from the point light source as planar illumination light, and such light source units are used in combination to make light displays of the characters.

6. The light display device according to claim 5, wherein a character case corresponding to each character and having an opening is provided, the light source units are each stored in the character case, and the opening is covered with a light diffusion plate.

7. The light display device according to claim 6, wherein the light diffusion plate includes a cover covering the opening of the character case and the opening is sealed up with the cover.

8. The light display device according to claim 5, wherein the light reflection plate is apart from the point light source by a predetermined distance and includes a center reflection part having high light reflectivity and low light transmittance in a predetermined region of which center is the optical axis of the point light source and an outer reflection part having a gradually reduced light reflectivity and an increased light transmittance as the distance from the periphery of the center reflection part increases.
